(19) United States
(12) Patent Application Publication
(10) Pub. No.: US 2024/0364527 A1
(43) Pub. Date: Oct. 31, 2024

(54) METHOD FOR PROCESSING BIOMETRIC DATA, AND ASSOCIATED SYSTEM AND COMPUTER PROGRAM

(71) Applicant: IDEMIA IDENTITY & SECURITY FRANCE, Courbevoie (FR)

(72) Inventors: Hervé CHABANNE, Courbevoie (FR); Alberto IBARRONDO, Courbevoie (FR)

(73) Assignee: IDEMIA IDENTITY & SECURITY FRANCE, Courbevoie (FR)

(21) Appl. No.: 18/645,601

(22) Filed: Apr. 25, 2024

(30) Foreign Application Priority Data
Apr. 25, 2023 (FR) 2304129

(51) Int. Cl. H04L 9/32; H04L 9/08; H04L 9/30

(52) U.S. Cl. CPC H04L 9/3231; H04L 9/0866; H04L 9/3093

(57) ABSTRACT

A method for processing biometric data, comprising: functionally encrypting a test biometric datum, which is a vector comprising n test components representative of a biometric trait of a candidate individual, and at least one other non-zero test component representative of a first masking element, obtaining a score representing a distance, between the test biometric datum and a reference biometric datum, in a form masked by a primary mask, by functionally decrypting the encrypted test biometric datum, using a functional decryption key for a 1st-degree or 2nd-degree polynomial function parameterized with said reference biometric datum, the reference biometric datum being another vector comprising n reference components representative of a biometric trait of a reference individual and at least one other non-zero reference component representative of a second masking element.

The invention relates to a method for processing biometric data for comparison between a test biometric datum and at least one reference biometric datum.

There are already identification or authentication schemes in which a user, also referred to as a candidate individual, presents, to a trustworthy processing unit, for example to a unit belonging to a customs office, an airport, etc., a biometric datum freshly acquired from the user, which the unit compares against one or more reference biometric data recorded in a reference database to which it has access.

This reference database groups together the reference biometric data of author-ized individuals, also referred to as reference individuals, such as passengers on a flight prior to boarding.

Application FR3123130A1 discloses a method for processing biometric data that is intended to be used to identify or authenticate a candidate individual and is based on a clever mechanism based on a functional cryptographic encryption algorithm.

The functional cryptographic encryption algorithm may be as described in “Function-Hiding Inner Product Encryption is Practical”, Sam Kim, Kevin Lewi, Avradip Mandal, Hart Montgomery, Arnab Roy, and David J. Wu SCN 2018: 544-562.

For each reference biometric datum, a functional private decryption key is gen-erated so as to compile a functional private decryption key base.

A test biometric datum representative of a biometric trait of the candidate indi-vidual is encrypted using a functional public encryption key.

To compute a distance between the test biometric datum and a reference bio-metric datum, the encrypted test biometric datum is decrypted by functional de-cryption using the functional private decryption key generated from the refer-ence biometric datum.

It is thus possible to make do with a reference database containing private decryption keys, each associated with a reference biometric datum (it is not necessary to keep the reference biometric datum), but that does not make it possi-ble to trace this reference biometric datum.

This is also highly advantageous in terms of data storage size.

Such a solution is satisfactory, but the distances computed between a reference biometric datum and multiple test biometric data may leak information con-cerning the reference biometric datum.

To limit the amount of information liable to be leaked, the number of functional decryptions able to be executed using one and the same functional pri-vate decryption key is restricted.

This restriction limits the number of identifications or authentications able to be carried out with a reference database.

It would therefore be desirable to have a simple, reliable, secure and privacy-friendly solution that overcomes this drawback for the identification and/or au-thentication of an individual.

To this end, the present invention proposes, according to a first aspect, a method for processing biometric data, the method comprising the implementa-tion, by a system, of the following steps:
functionally encrypting a test biometric datum using a functional encryption key,
for at least one reference biometric datum, obtaining a score representing a distance between the test biometric datum and the reference biometric datum, by functionally decrypting the encrypted test biometric datum, using a functional decryption key for a 1st-degree or 2nd-degree polynomial function parameterized with said reference biometric datum,
   the method being characterized in that:
the test biometric datum is a vector comprising n test components representative of a biometric trait of a candidate individual, where n is a natural number strictly greater than zero, and at least one other non-zero test component representative of a first masking element,
the reference biometric datum is another vector comprising n reference components representative of a biometric trait of a reference individual and at least one other non-zero reference component representative of a second masking ele-ment, and
the score obtained by functional decryption represents the distance between the test bi-ometric datum and the reference biometric datum in a form masked by a pri-mary mask.

According to some advantageous and non-limiting features:
the value of the primary mask is the result of the application, to the at least one other test component, of the 1st-degree or 2nd-degree polynomial function parame-terized with the at least one other reference component;
the method furthermore comprises determining, by way of a random or pseudorandom draw, a value of at least one other component from the at least one other refer-ence component and the at least one other test component;
the method furthermore comprises an enrollment step comprising generating said functional decryption key for said 1st-degree or 2nd-degree polynomial function parameterized with said reference biometric datum, from a master key and said reference biometric datum;
said functional decryption key for said 1st-degree or 2nd-degree polynomial function parameterized with said reference biometric datum is generated by applying said 1st-degree or 2nd-degree polynomial function between said master key and said reference biometric datum;
the enrollment step comprises generating said functional encryption key from said master key;
the enrollment step comprises generating said master key, obtaining at least one reference biometric datum, and, for each reference biometric datum that is obtained, generating the functional decryption key for said 1st-degree or 2nd-degree pol-ynomial function parameterized with said reference biometric datum, so as to compile a functional decryption key base;
the functional encryption step comprises obtaining said test biometric datum from the biometric trait of the candidate individual using biometric acquisition means of the system;
the 1st-degree or 2nd-degree polynomial function is a scalar product;
the method furthermore comprises, for values of i equal to 1 and 2, implementing the following step by way of a device of index i of the system: generating a partial result of index i from the score and an unmasking datum of index i associated with the primary mask;
the devices of respective indices 1 and 2 are distinct;
the partial results of respective indices 1 and 2 make it possible to compute a check result indicating whether or not the test biometric datum corresponds to the refer-ence biometric datum;
the check result is equal to the sum of the partial results of respective indices 1 and 2;
the functional encryption of the test biometric datum is implemented by a device of the system, distinct from the devices of indices 1 and 2, and/or the check result is computed from the partial results of respective indices 1 and 2 by an output de-vice of the system, distinct from the devices of indices 1 and 2.

According to a second aspect, the invention proposes a computer program comprising code instructions for executing a method for processing biometric data as defined above when this program is executed by a system.

According to a third aspect, the invention proposes a storage means able to be read by computer equipment and on which a computer program comprises code instructions for executing a method for processing biometric data as defined above.

According to a fourth aspect, the invention proposes a system for processing biometric data, the system being configured to implement the following steps:
functionally encrypting a test biometric datum using a functional encryption key,
for at least one reference biometric datum, obtaining a score representing a distance between the test biometric datum and the reference biometric datum, by functionally decrypting the encrypted test biometric datum using a functional decryption key for a 1st-degree or 2nd-degree polynomial function parameterized
with said reference biometric datum,
   and the system being characterized in that:
the test biometric datum is a vector comprising n test components representative of a biometric trait of a candidate individual, where n is a natural number strictly greater than zero, and at least one other non-zero test component representative of a first masking element,
the reference biometric datum is another vector comprising n reference components representative of a biometric trait of a reference individual and at least one other non-zero reference component representative of a second masking ele-ment, and
the score obtained by functional decryption represents the distance between the test bi-ometric datum and the reference biometric datum in a form masked by a pri-mary mask.

This system may be configured to implement each of the possible embodi-ments envisaged for the method for processing biometric data as defined above.

Of course, the various features, variants and embodiments of the invention may be combined with one another in a variety of combinations provided that they are not incompatible or mutually exclusive.

Other features and advantages of the present invention will become apparent from the description given below, with reference to the appended figures, which illustrate exemplary embodiments of the invention that are completely non-limiting in nature.

In the figures:

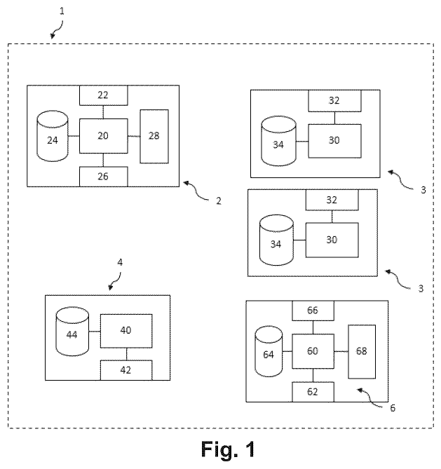

FIG. 1 schematically shows one preferred embodiment of a system for implementing a method according to the invention;

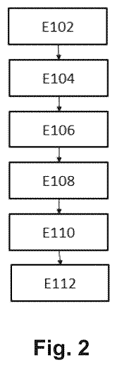

FIG. 2 illustrates the steps of one embodiment of a method according to the invention.

FIG. 1 schematically shows a system 1 for processing biometric data for implementing a method for processing biometric data for the purpose of authenti-cating/identifying candidate individuals.

In one embodiment, the system 1 implements authentication of a candidate individual, that is to say compares the biometric datum, referred to as a test biometric datum (freshly acquired from the candidate individual), with a single reference biometric datum, supposed to originate from the same individual, in order to verify that the individual from which the two data were obtained is in-deed the same individual.

In another embodiment, the system 1 implements identification of the candidate individual, that is to say compares the test biometric datum with all of the reference biometric data in a base, in order to determine the identity of the can-didate individual.

Typically, both the test biometric datum and each reference biometric datum are vectors in one and the same vector space. The test biometric datum comprises n test components representative of a biometric trait of a candidate individual, with n being a natural number strictly greater than zero. Each reference biometric datum comprises n reference components representative of a bio-metric trait of a reference individual.

This system 1 is equipment owned and controlled by an entity with which authentication/identification is to be performed, for example a government entity, a customs entity, a company, etc. In the remainder of the present description, the example of an airport will be adopted, the system 1 typically aiming to con-trol the access of passengers on a flight before they board.

The system 1 comprises a control device 2, at least one pair of participating de-vices 3, and a trusted device 4 and an enrollment device 6.

The control device 2 comprises a processor 20, a communication interface 22 for communicating with the trusted device 4 and with each participating device 3, a memory 24 and a biometric sensor 26.

The processor 20 is configured to implement some steps of a method that will be described later. The processor may have any structure. The processor com-prises one or more cores, each core being configured to execute the code in-structions of a program so as to implement the aforementioned steps.

The communication interface 22 is for example of wireless radio type, and uses any communication protocol (Wi-Fi, Bluetooth, etc.).

The communications between the communication interface 22 of the control device 2 and communication interfaces 32 of the participating devices 3 may use protocols that are identical to or else different from the communications be-tween the communication interface 22 of the control device 2 and a communi-cation interface 42 of the trusted device 4.

The memory 24 is designed to store data manipulated or produced by the pro-cessor 20. The memory 24 is of any type. Conventionally, the memory com-prises a volatile memory for storing data temporarily, and a non-volatile memory for storing data persistently, that is to say in a manner that preserves the data when the non-volatile memory is switched off.

The biometric sensor 26 is configured to acquire biometric data relating to indi-viduals. For example, the biometric sensor comprises a camera configured to acquire images showing the face of a candidate individual, and to extract test components from such images. As an alternative or in addition, the biometric sensor comprises a fingerprint sensor and/or an iris sensor. Various image processing techniques for extracting components representative of the individual, typically test components representative of the candidate individual, are known to those skilled in the art. By way of non-limiting example, extracting the components representative of the individual may comprise extracting particular points or a shape of the face if the image is an image of the face of the individual.

In one embodiment, the control device 2 furthermore comprises a gate 28 that may be closed in order to prevent an individual from accessing a secure area, and may be opened in order to allow such access. The processor 20 is in this case configured to control the opening and closure of the gate 28. For example, the control device 2 is located in an airport, and the secure area is a boarding area; in this specific application, the candidate individuals wishing to access the boarding area are passengers on a flight, whose identity needs to be checked before boarding.

Each participating device 3 comprises a processor 30, a communication interface 32 for communicating with the control device 2, with the trusted device 4 and with the enrollment device 6, and a memory 34. The information provided above with regard to the processor 20, the communication interface 22 and the memory 24 is also applicable to the processor 30, the communication interface 32 and the memory 34.

The communications between the communication interface 32 of a participating device 3 and the communication interface 22 of the control device 2 may use protocols that are identical to or else different from the communications be-tween the interface 32 of the participating device 3 and the communication in-terface 42 of the trusted device 4 and/or the communications between the inter-face 32 of the participating device 3 and a communication interface 62 of the enrollment device 6.

The participating devices 3 are distinct from one another. A detailed description will be given below of an embodiment in which the participating devices 3 are distinct from the control device 2, from the trusted device 4 and from the en-rollment device 6, as shown in FIG. 1. However, in other embodiments, it may be envisaged for the control device 2 and/or the enrollment device 6 to constitute one of the participating devices 3.

Each memory 34 stores a reference database, which is a functional decryption key base, each functional decryption key in said base being associated with a reference biometric datum relating to a previously enrolled individual, also referred to as reference individual. The reference biometric data are not stored in the reference database. A functional decryption key does not make it possible to trace the associated reference biometric datum. The reference biometric data are thus confidentiality-protected.

The trusted device 4 has the function of generating a cryptographic key referred to as master key, a primary mask, masking elements associated with the primary mask, and unmasking data associated with the primary mask, which are used by other devices of the system. The trusted device 4 comprises a pro-cessor 40, a communication interface 42 for communicating with the control

device 2, with the enrollment device 6 and with each participating device 3, and a memory 44. The information provided above with regard to the processor 20, the communication interface 22 and the memory 24 is also applicable to the processor 40, the communication interface 42 and the memory 44.

The communications between the communication interface 42 of the trusted device 4 and the communication interface 22 of the control device 2, the com-munications between the communication interface 42 of the trusted device 4 and the communication interface 62 of the enrollment device 6, and the com-munications between the communication interface 42 of the trusted device 4 and the interface 32 of a participating device 3 may use identical or different protocols.

The enrollment device 6 comprises a processor 60, a communication interface 62 for communicating with the trusted device 4 and with each participating de-vice 3, a memory 64, a biometric sensor 66 and a document reader 68. The in-formation provided above with regard to the processor 20, the communication interface 22, the memory 24 and the biometric sensor 26 is also applicable to the processor 60, the communication interface 62, the memory 64 and the bio-metric sensor 66. The document reader 68 is typically an image sensor, such as for example a digital photographic camera or a digital camera, designed to ac-quire an image of an identity document (for example a passport), and/or a con-tact-based or contactless communication means (for example NFC, UHF, etc.) designed to read the contents of a chip of an identity document.

A detailed description will be given below of an embodiment in which the enrollment device 6 is distinct from the control device 2 and from the trusted de-vice 4. However, in other embodiments, the control device 2 or the trusted de-vice 4 could be used as the enrollment device 6.

FIG. 2 illustrates the steps of one embodiment of a method according to the invention.

The reference biometric data may have been compiled in advance.

Each reference biometric datum is advantageously a datum recorded in an identity document of a reference individual. For example, the reference biometric datum may be a biometric datum obtained from an image of the face on an identity document (for example a passport), or else an image of the face or of at least one iris of the individual recorded in a radiofrequency chip contained in the identity document.

The invention uses functional encryption for a 1st-degree or 2nd-degree polynomial function parameterized with a reference biometric datum. It will thus be understood that there are as many different functions as there are reference bio-metric data. Preferably, said polynomial function parameterized with a refer-ence biometric datum is a function “of distance from the reference biometric datum”. thus making it possible to compare the input of the function with the

reference biometric datum, and preferably the function “scalar product with the reference biometric datum”, although it is possible to use other distance func-tions, for example Euclidean distance, which is 2nd-degree.

As will be seen, the invention is distinguished in that the input datum is a vector comprising at least n test components representative of a biometric trait of a candidate individual and at least one other non-zero test component representa-tive of a first masking element, and in that the reference biometric datum com-prises n reference components representative of a biometric trait of a reference individual and at least one other non-zero reference component representative of a second masking element. n is a natural number strictly greater than zero.

According to a first example, the input datum X is a vector the components of which are (x₁, . . . , xₙ,u) and the reference biometric datum Y is a vector the components of which are (y₁, . . . ,yₙ,m), where xₖ is the test component of rank k representative of the biometric trait of the candidate individual, u is said at least one other test component representative of a first masking element (u), yₖis the reference component of rank k representative of the biometric trait of the refer-ence individual, and m is said at least one other reference component repre-sentative of a second masking element (m).

According to a second example, the input datum X is a vector the components of which are (x₁, . . . , xₙ,u,v) and the reference biometric datum Y is a vector the components of which are (y₁, . . . ,yₙ,m,t), where xₖ is the test component of rank k representative of the biometric trait of the candidate individual, u and v are two other test components representative of a first masking element (u,v), yₖ is the reference component of rank k representative of the biometric trait of the reference individual, and m and t are two other reference components repre-sentative of a second masking element (m,t).

The results of the functional decryption of a cipher of the input datum, also re-ferred to hereinafter as score, is thus directly the result of the application, to this input datum, of the 1st-degree or 2nd-degree polynomial function parameterized with the reference biometric datum, that is to say the distance of this in-put datum from said reference biometric datum in a form masked by a primary mask r. The primary mask r depends on the first masking element and on the second masking element, that is to say on the at least one other test component and at least one other reference component.

The value of the primary mask r is the result of the application, to the at least one other test component, of the 1st-degree or 2nd-degree polynomial function parameterized with the at least one other reference component.

The proposed method provides security because the unencrypted distance is never computed.

When the 1st-degree or 2nd-degree polynomial function is a scalar product and when the test biometric datum and the reference biometric datum are defined according to the first example described above, the score s has the value uu·mm+Σₖₖ₌₁ⁿⁿ xxₖₖ·yyₖₖ, the primary mask r having the value uu·mm and the distance having the value Σₖₖ₌₁ⁿⁿ xxₖₖ·yyₖₖ.

When the 1st-degree or 2nd-degree polynomial function is a scalar product and when the test biometric datum and the reference biometric datum are defined according to the second example described above, the score s has the value uu·mm+vv·tt+Σₖₖ₌₁ⁿⁿ xxₖₖ·yyₖₖ, the primary mask r having the value uu·mm+vv·tt and the distance having the value Σₖₖ₌₁ⁿⁿ xxₖₖ·yyₖₖ.

It is thus sufficient to have multiple decryption keys (sk₁, sk₂, etc.), each one associated with a reference biometric datum, in order to be able to compute the polynomial function for each of these reference biometric data, that is to say distances in masked form from all of these reference biometric data like so many different functions.

Denoting:
Dec as the functional decryption function,
Enc as the functional encryption function,
Yⱼ as the j-th reference biometric datum,
X as a test biometric datum,
r as the primary mask,
d(A,B) as the distance between A and B,
fⱼ as said 1st-degree or 2nd-degree polynomial function parameterized with Yⱼ,
pk as the functional encryption key,
skⱼ as the functional decryption key for the function fⱼ,
   then if the polynomial function is a distance function, this gives:

$$Dec ( {sk}_{j} , Enc ( p k , X ) ) = {f}_{j} ( X ) = d ( X , {Y}_{j} ) + r .$$

Preferably, the one or more decryption keys associated with each reference bio-metric datum are generated on the fly from said reference biometric datum, meaning that the reference biometric data are not stored (thereby avoiding any risk of disclosure, and also being highly economical in terms of storage size), and a decryption key base is compiled live, rather than a reference biometric database. For example, each decryption key is generated directly when the cor-responding identity document is read.

In this regard, with reference to FIG. 2, the method preferably begins with an enrollment step (step E102), comprising generating said functional decryption key for the 1st-degree or 2nd-degree polynomial function parameterized with said reference biometric datum, from a master key and said reference biometric datum.

Indeed, functional encryption provides this possibility of using a secret master key, and in the case of a 1st-degree or 2nd-degree polynomial function, said functional decryption key for the 1st-degree or 2nd-degree polynomial function

parameterized with said reference biometric datum is typically generated by applying said 1st-degree or 2nd-degree polynomial function between said master key and said reference biometric datum, for example by applying a scalar product between said master key and said reference biometric datum if said function is the scalar product.

The generation of said functional decryption key is typically implemented by the enrollment device 6, and the memory 64 of the enrollment device stores the generated decryption key. The enrollment device 6 sends the generated decryption key to the participating devices 3, typically using its communication interface 62. Each participating device 3 receives the generated decryption key from the enrollment device 6, typically using its communication interface 32, and then stores said decryption key in its memory 34.

The enrollment step (step E102) may also comprise generating said functional encryption key from the same master key, thereby making it possible to have associated encryption and decryption keys. The generation of said functional encryption key is typically implemented by the control device 2.

According to another possibility, the generation of said functional encryption key is implemented by the trusted device 4, and then the trusted device 4 sends the generated functional encryption key to the control device 2, typically using its communication interface 42. The control device 2 receives the generated functional encryption key from the trusted device 4, typically using its commu-nication interface 22, and then stores said encryption key in its memory 24.

It is possible to have a single master key, but alternatively there is one master key per “session”, that is to say per group of identifications/authentications. For example, in the case of checking passengers before boarding, there is one master key per flight, which may be drawn from a list, generated randomly or using a pseudorandom algorithm, etc.

Thus, particularly preferably, the enrollment step (step E102) comprises gener-ating said master key, typically by way of the trusted device 4. For example, the master key is generated randomly or using a pseudorandom algorithm, etc. The master key is stored in the memory 44.

The trusted device 4 may send the master key to the enrollment device 6 and to the control device 2, typically using its communication interface 42.

Also preferably, the enrollment step (step E102) comprises obtaining at least one reference biometric datum Yⱼ, typically by way of the enrollment device 6, and, for each reference biometric datum Yⱼ that is obtained, generating, typically by way of the enrollment device 6, the functional decryption key skⱼ for the 1st-degree or 2nd-degree polynomial function parameterized with said reference biometric datum Yⱼ, so as to compile a base of functional decryption keys skⱼ. The encryption key pk is also generated at the same time, typically by the control device 2.

The enrollment device 6 sends a generated decryption key to the participating devices 3, typically using its communication interface 62. A participating device 3 receives a decryption key from the enrollment device 6, typically using its communication interface 32, and then stores said decryption key in its memory 34.

According to another possibility, the enrollment device 6 sends the decryption key base to the participating devices 3, typically using its communication inter-face 62. Each participating device 3 receives the decryption key base from the enrollment device 6, typically using its communication interface 32, and then stores said decryption key base in its memory 34.

The reference biometric data Yⱼ might not have been compiled in advance.

In this case, each reference biometric datum may advantageously be obtained

from a datum recorded in an identity document of a reference individual, typically reference components representative of the reference individual. For example, the reference components may be obtained from an image of the face on an identity document (for example a passport), or else an image of the face or of at least one iris of the individual recorded in a radiofrequency chip contained in the identity document.

Obtaining at least one reference biometric datum Yⱼ may thus comprise, for each reference biometric datum Yⱼ, obtaining the reference components representative of the reference individual, typically by way of the enrollment device 6 via its document reader 68, and then concatenating said reference compo-nents with the other reference components, the reference biometric datum Yⱼ being the result of this concatenation.

When the reference data are compiled in advance, at least one reference biometric datum is advantageously obtained, for each reference biometric datum, from an identity document (for example a passport), typically via the document reader 68 of the enrollment device 6.

Also preferably, the enrollment step (step E102) comprises determining, by way of a random or pseudorandom draw, a value of at least one other component from the at least one other reference component and the at least one other test component.

For example, u is determined by way of a random draw, and m has a predeter-mined value, typically 1, or vice versa.

Advantageously, when the reference biometric data are compiled in advance, the at least one other reference component has a predetermined value.

According to another example, u and m are determined by way of a random draw.

This determination is typically implemented by the trusted device 4.

The trusted device 4 may send the at least one other determined reference com-ponent to the enrollment device 6, typically using its communication interface

42. The enrollment device 6 receives the at least one other reference component from the trusted device 4, typically using its communication interface 62.

The trusted device 4 may also send the at least one other test component to the control device 2, typically using its communication interface 42. The control device 2 receives the at least one other test component from the trusted device 4, typically using its communication interface 22.

When at least one other reference component and at least one other test component are determined by way of a random or pseudorandom draw, security is increased.

The method itself begins with a functional encryption step (step E104) of func-tionally encrypting a test biometric datum X using said functional encryption key pk.

This step is typically implemented by the control device 2.

It is important to understand that, although the enrollment may be implemented well before the authentication/identification itself, the test biometric datum X must be obtained at most a few minutes before, in order to guarantee the “freshness” of the test components of the test biometric datum.

Advantageously, the functional encryption step (step E104) comprises obtaining said test biometric datum X from a biometric trait of the candidate individ-ual using biometric acquisition means of the system 1, typically the biometric sensor 26 of the control device 2.

As explained, the control device 2 comprises a biometric sensor 26 for obtaining fresh test components. In general, the test biometric datum X is generated by the processor 20 from a biometric trait provided by the biometric sensor 26, typically by concatenating said test components with the other test components, the test biometric datum X being the result of this concatenation. However, the biometric sensor 26 may comprise processing means for extracting the test components and may for example take the form of an automatic device provided by control authorities (in the airport). Such an automatic device may, where necessary, concatenate said test components with the other test compo-nents.

Preferably, the biometric sensor 26 is capable of detecting life, so as to ensure that the test biometric datum X has come from a “real” trait.

If the biometric sensor 26 and the control device 2 are remote, the communica-tion between the two may be encrypted.

The present method is distinguished as explained, highly originally, in that the test biometric datum X is a vector comprising at least n test components repre-sentative of a biometric trait of a candidate individual, where n is a natural number strictly greater than zero, and at least one other non-zero test compo-nent representative of a first masking element.

The method continues with a step of obtaining a score (step E106), during which the system 1 obtains, for at least one reference biometric datum Yⱼ, a score s representing a distance between the test biometric datum X and said reference biometric datum Yⱼ by functionally decrypting the encrypted test bio-metric datum using a functional decryption key skⱼ for a 1st-degree or 2nd-de-gree polynomial function parameterized with said reference biometric datum Yⱼ.

Thanks to the at least one other reference component of the reference biometric datum and the at least one other test component of the test biometric datum, the result of the functional encryption is not the distance of this test biometric da-tum X from said reference biometric datum Yⱼ in unencrypted form, but the distance of this test biometric datum X from said reference biometric datum Yⱼin a form masked by the primary mask r.

The proposed method provides security because the unencrypted distance is never computed.

The method thus makes it possible to prevent an attacker from obtaining information relating to a reference biometric datum, without limiting the number of iterations of the method for one and the same reference biometric datum.

The step of obtaining a score (step E106) is typically implemented by each participating device 3 of the system 1. Each participating device 3 thus obtains, for a given test biometric datum X and a given reference biometric datum Yⱼ, the distance of this test biometric datum X from this reference biometric datum Yⱼ in a form masked by the primary mask r.

According to another possibility, a single device of the system I may implement the step of obtaining a score (step E106), typically a participating device 3.

The method may furthermore comprise, for values of i equal to 1 and 2, imple-menting a generation step (step E108), carried out by a participating device 3 of index i, of generating a partial result oi of index i from the score s and from an unmasking datum kᵢ of index i.

The participating devices 3 of respective indices 1 and 2 are distinct.

The generation step (step E108) is thus implemented by each participating de-vice 3 of at least one pair of participating devices 3 of the system 1.

The partial results of respective indices 1 and 2 make it possible to compute a check result (o) indicating whether or not the test biometric datum corresponds to the reference biometric datum.

The method thus makes it possible to integrate the computing of the distance between the test biometric datum and the reference biometric datum and the comparison of the computed distance with a threshold without computing or manipulating the distance in unencrypted form, thereby making the method even more secure against attacks seeking to obtain information about the refer-ence biometric datum.

Moreover, the method makes it possible to generate partial results without the participating devices 3 of respective indices 1 and 2 needing to exchange infor-mation with one another.

If a participating device 3 of index i does not compute the score s during the step of obtaining a score (step E106) of the method, this participating device 3 of index i may receive the score s from a device of the system 1 that has com-puted said score s, typically via its communication interface 32.

It should be noted that a device manipulating a score s, typically a device implementing the step of obtaining a score (step E106) and/or the step of generat-ing a partial result (step E108), for example a participating device 3, must not have all of the other test components and all of the other reference components or the primary mask, so as to ensure the security of the reference biometric da-tum.

The unmasking data of respective indices 1 and 2 are typically generated during the enrollment step (step E102) with the primary mask r, preferably by the trusted device 4, which then sends the unmasking datum of index 1 to the participating device of index 1, and the unmasking datum of index 2 to the participating device of index 2. For example, the primary mask r and the two unmask-ing data of respective indices 1 and 2 are generated by the Funshade.Setup( ) function described in the document “Funshade: Functional Secret Sharing for Two-Party Secure Thresholded Distance Evaluation”, Alberto Ibarrondo, Hervé Chabanne and Melek Önen, https://eprint.iacr.org/2022/1688/, and then the at least one other reference component and the at least one other test component are determined such that the value of the primary mask r is the result of the ap-plication, to the at least one other test component, of the 1st-degree or 2nd-de-grec polynomial function parameterized with the at least one other reference component. Typically, when the 1st-degree or 2nd-degree polynomial function is a scalar product and when the test biometric datum and the reference bio-metric datum are defined according to the first example described above, the at least one other test component u may be determined as follows: u=r.m⁻¹, the at least one other reference component m having a predetermined value or having a value determined by way of a random or pseudorandom draw.

It should be noted that a device manipulating a score s must not have the un-masking datum of index 1 and the unmasking datum of index 2 at the same time.

Preferably, the functional encryption of the test biometric datum is implemented by a device distinct from the participating devices 3 of indices 1 and 2.

During the step of generating a partial result (step E108), the participating device 3 of index i computes a partial result oi of index i from the score s and from the unmasking datum kᵢ of index i: oᵢ=FSS.eval (i.kᵢ.s), and then the par-ticipating device 3 of index i sends the partial result oi to an output device. for

example the control device 2, via its communication interface 32. The FSS.eval function is typically as described in the document “Funshade: Functional Se-cret Sharing for Two-Party Secure Thresholded Distance Evaluation”, Alberto Ibarrondo, Hervé Chabanne and Melek Önen, https://eprint.iacr.org/2022/1688/.

As indicated above, the processing constituted by the step of generating a partial result (step E108) is implemented twice: once by the participating device of index 1 and once by the participating device of index 2. Two partial results o₁, o₂ are thus generated.

The method continues with a step of obtaining a check result o (step E110), during which the system 1 computes a check result from the partial results of respective indices 1 and 2.

The pair of partial results has the property of making it possible to compute a check result o indicating whether or not the test biometric datum corresponds to the reference biometric datum. However, it is not possible to compute this check result on the basis of just one of the two partial results.

The step of obtaining a check result o (step E110) is typically implemented by an output device distinct from the devices of indices 1 and 2, here the control device 2, which has received the pair of partial results o₁, o₂ from the two par-ticipating devices 3, for example via its communication interface 22.

In one embodiment, the check result is obtained by summing the partial results, as follows: o=oo₁+oo₂.

Ultimately, the functional encryption, and then the functional decryption, the generation of partial results and the step of obtaining a check result enable a comparison between a threshold and the distance between the test biometric datum and the reference biometric datum. The threshold is defined in the FSS.Setup( ) function used to generate the primary mask and the unmasking data (the threshold is encoded by these data, as it were).

In practice, the check result may be a Boolean.

If the check result indicates that the test biometric datum corresponds to the reference biometric datum, then the candidate individual to which the test biometric datum relates is considered to have previously been enrolled with the system 1. Under these conditions, the processor 20 may, in an access control step (step E112), order the gate 28 to open in order to allow the candidate indi-vidual to access a secure area.

If the check result indicates that the test biometric datum does not correspond to the reference biometric datum, then the individual being checked, that is to say the candidate individual, is considered not to be the reference individual to which the reference biometric datum relates.

The preceding steps (in particular the step of obtaining a score, the step of generating a partial result and the step of obtaining a check result) may be implemented U times for various decryption keys relating to different reference biometric data.

These U implementations may be sequential. As a variant, it is possible to launch U processes in parallel, each implementing the step of obtaining a score, the step of generating a partial result and the step of obtaining a check result described above, and to aggregate the final results in the access control step.

The method described above may be subject to other variants.

The primary mask, the at least one other test component, the at least one other reference component and the unmasking data may be determined once and for-ever for the system 1.

As an alternative, the primary mask, the at least one other test component, the at least one other reference component and the unmasking data are generated, typically during the enrollment step, per “session”.

According to another possibility, the primary mask, the at least one other test component and the unmasking data are single-use data for a test biometric datum. With this possibility, the primary mask, the at least one other test component and the unmasking data may be able to be reused multiple times, for various reference individuals, when checking the candidate individual to whom the test biometric datum relates.

Consequently, the primary mask, the at least one other test component and the unmasking data may be generated during the functional encryption step.

In one particularly advantageous embodiment, only one pair of participating devices 3 of respective indices 1 and 2 is used. The inventors were able to ob-serve that this embodiment is easy to implement, while being reasonably fast and secure. However, it is also possible to use multiple pairs of participating devices implementing the method described above.

For each pair of participating devices 3, the sum of the partial results of the pair is equal to the check result. On the other hand, the trusted device 4 may pro-vide different pairs of participants with different unmasking data. The benefit of using multiple pairs of devices 3 is that of providing redundancy so as to en-sure that there has not been a computing error by a pair, for example in the event of attacks.

In the method described above, each memory 34 stores a reference database, which is a functional decryption key base.

According to one variant, no memory 34 stores the functional decryption key base, the functional decryption key base being stored in the memory 64 of the enrollment device 6. A participating device 3 that implements the step of obtaining a score (step E106) may then obtain the functional decryption key required in order to execute this step from the enrollment device (via the communication interface 32 of said participating device and the communication interface 62 of the enrollment device) and then erase said received decryption key once the step of obtaining a score has finished being executed.

One particular application of the method, in which the result of the check is a condition for accessing a secure area, has been discussed above. However, it will be understood that the described method may be used for other applica-tions.

1. A method for processing biometric data, the method comprising, by a system having circuitry:
functionally encrypting a test biometric datum using a functional encryption key;
for at least one reference biometric datum , obtaining a score representing a distance between the test biometric datum and the reference biometric datum, by functionally decrypting the encrypted test biometric datum using a functional decryption key for a 1st-degree or 2nd-degree polynomial function parameterized with said reference biometric datum;
generating said functional decryption key for said 1st-degree or 2nd-degree polynomial function parameterized with said reference biometric datum, from a master key and said reference biometric datum, and generating said functional encryption key from said master key,
wherein:
the test biometric datum is a vector having n test components representative of a biometric trait of a candidate individual, where n is a natural number strictly greater than zero, and at least one other non-zero test component representative of a first masking element,
the reference biometric datum is another vector having n reference components representative of a biometric trait of a reference individual and at least one other non-zero reference component representative of a second masking element, and
the score obtained by functional decryption represents the distance between the test biometric datum and the reference biometric datum in a form masked by a primary mask.

2. The method as claimed in claim 1, wherein a value of the primary mask is a result of an application, to the at least one other test component, of the 1st-degree or 2nd-degree polynomial function parameterized with the at least one other reference component.

3. The method as claimed in claim 1, further comprising determining, by way of a random or pseudorandom draw, a value of at least one other component from the at least one other reference component and the at least one other test component.

4. The method as claimed in claim 1, wherein said functional decryption key for said 1st-degree or 2nd-degree polynomial function parameterized with said reference biometric datum is generated by applying said 1st-degree or 2nd-degree polynomial function between said master key and said reference biometric datum.

5. The method as claimed in claim 1, wherein the generating further comprises:
generating said master key;
obtaining at least one reference biometric datum; and
for each reference biometric datum that is obtained, generating the functional decryption key for said 1st-degree or 2nd-degree polynomial function parameterized with said reference biometric datum, to compile a functional decryption key base.

6. The method as claimed in claim 1, wherein the functional encrypting further comprises obtaining said test biometric datum from the biometric trait of the candidate individual using biometric acquisition means of the system.

7. The method as claimed in claim 1, wherein the 1st-degree or 2nd-degree polynomial function is a scalar product.

8. The method as claimed in claim 1, further comprising, for values of i equal to 1 and 2, and by way of a device of index i of the system:
generating a partial result of index i from the score and an unmasking datum of index i associated with the primary mask,
wherein:
the devices of respective indices 1 and 2 are distinct, and
partial results of respective indices 1 and 2 make it possible to compute a check result indicating whether or not the test biometric datum corresponds to the reference biometric datum.

9. The method as claimed in claim 8, wherein the check result is equal to a sum of the partial results of respective indices 1 and 2.

10. The method as claimed in claim 9, wherein the functional encryption of the test biometric datum is implemented by a device of the system, distinct from the devices of indices 1 and 2, and/or the check result is computed from the partial results of respective indices 1 and 2 by an output device of the system, distinct from the devices of indices 1 and 2.

11. (canceled)

12. A non-transitory computer readable storage medium having stored thereon a computer program including code instructions for executing the method as claimed in claim 1.

13. A system for processing biometric data, comprising:
circuitry configured to:
functionally encrypt a test biometric datum using a functional encryption key,
for at least one reference biometric datum, obtain a score representing a distance between the test biometric datum and the reference biometric datum, by the circuitry being further configured to functionally decrypt the encrypted test biometric datum using a functional decryption key for a 1st-degree or 2nd-degree polynomial function parameterized with said reference biometric datum, and
generate said functional decryption key for said 1st-degree or 2nd-degree polynomial function parameterized with said reference biometric datum, from a master key and said reference biometric datum, and generate said functional encryption key from said master key,
wherein:
the test biometric datum is a vector including n test components representative of a biometric trait of a candidate individual, where n is a natural number strictly greater than zero, and at least one other non-zero test component representative of a first masking element,
the reference biometric datum is another vector comprising n reference components representative of a biometric trait of a reference individual and at least one other non-zero reference component representative of a second masking element, and
the score obtained by functional decryption represents the distance between the test biometric datum and the reference biometric datum in a form masked by a primary mask.

14. The method as claimed in claim 2, further comprising determining, by way of a random or pseudorandom draw, a value of at least one other component from the at least one other reference component and the at least one other test component.

15. The method as claimed in claim 2, wherein said functional decryption key for said 1st-degree or 2nd-degree polynomial function parameterized with said reference biometric datum is generated by applying said 1st-degree or 2nd-degree polynomial function between said master key and said reference biometric datum.

16. The method as claimed in claim 3, wherein said functional decryption key for said 1st-degree or 2nd-degree polynomial function parameterized with said reference biometric datum is generated by applying said 1st-degree or 2nd-degree polynomial function between said master key and said reference biometric datum.

17. The method as claimed in claim 2, wherein the generating further comprises:
generating said master key;
obtaining at least one reference biometric datum; and
for each reference biometric datum that is obtained, generating the functional decryption key for said 1st-degree or 2nd-degree polynomial function parameterized with said reference biometric datum, to compile a functional decryption key base.

18. The method as claimed in claim 3, wherein the generating further comprises:
generating said master key;
obtaining at least one reference biometric datum; and
for each reference biometric datum that is obtained, generating the functional decryption key for said 1st-degree or 2nd-degree polynomial function parameterized with said reference biometric datum, to compile a functional decryption key base.

19. The method as claimed in claim 4, wherein the generating further comprises:
generating said master key;
obtaining at least one reference biometric datum; and
for each reference biometric datum that is obtained, generating the functional decryption key for said 1st-degree or 2nd-degree polynomial function parameterized with said reference biometric datum, to compile a functional decryption key base.

20. The method as claimed in claim 2, wherein the functional encrypting further comprises obtaining said test biometric datum from the biometric trait of the candidate individual using biometric acquisition means of the system.

21. The method as claimed in claim 3, wherein the functional encrypting further comprises obtaining said test biometric datum from the biometric trait of the candidate individual using biometric acquisition means of the system.
